(19) United States
(12) Patent Application Publication
(10) Pub. No.: US 2016/0046839 A1
(43) Pub. Date: Feb. 18, 2016

(54) REMOVABLE SELF-ADHESIVE FILM

(71) Applicants: Masanori MARUNO, Nara (JP); Kenya YAMASHITA, Nara (JP); Kazuo MACHIDA, Kanagawa (JP); Motoki SHIGETO, Shizuoka (JP); Yuichiro KUBOTA, Shizuoka (JP)

(72) Inventors: Masanori MARUNO, Nara (JP); Kenya YAMASHITA, Nara (JP); Kazuo MACHIDA, Kanagawa (JP); Motoki SHIGETO, Shizuoka (JP); Yuichiro KUBOTA, Shizuoka (JP)

(21) Appl. No.: 14/459,443

(22) Filed: Aug. 14, 2014

(51) Int. Cl. C09J 7/02

(52) U.S. Cl. CPC C09J 7/0246; C09J 7/0285; C09J 151/003

(57) ABSTRACT

Provided is a removable self-adhesive film excellent in stylus-friendliness and the adhesiveness between an adhesive layer and a substrate layer.

The removable self-adhesive film includes a substrate layer, an adhesive layer, and a primer layer between the substrate layer and the adhesive layer, in which the adhesive layer comprises a vinyl group-containing thermoplastic elastomer, an acrylic acid ester, a photopolymerization initiator, and a plasticizer, and the primer layer is composed of a polymer that comprises a polyester-based polymer as a main component and has a hydroxyl group or a vinyl group.

### BACKGROUND OF THE INVENTION

1. Field of the Invention

The present invention relates to a removable self-adhesive film which can be suitably used for efficiently protecting surfaces requiring protection, such as a display screen of televisions, personal computers, cellular phones, game consoles, smart phones, and car navigation systems, and can be suitably used as an adhesive window film for POP advertising and the like. The present invention also relates to a removable self-adhesive film which is stylus-friendly.

2. Background Art

Protective films are used for protecting a display screen of televisions, personal computers, cellular phones, and the like. It is required for these protective films to maintain self-adhesiveness even if they are repeatedly attached and peeled for attaching operation and replacement of film. The films are required to be easily peeled and not to leave an adhesive on an adherend surface when they are removed. Furthermore, adhesive window films for POP advertising and the like are also required to have the same performance.

There is a demand for a film that makes it possible to efficiently release and push out air from the boundary surface between the film and an adherend surface, in the operation of attaching the film to the adherend surface. Particularly, since the adhesive window film for POP advertising and the like has a large area, and air easily enters the film, push-out properties of air are important. In view of physical properties and external appearance, the accumulation of air between the film and the adherend surface is not preferable. In order to prevent the accumulation of air, a bonding operation should be carefully performed, or alternatively, a specific bonding apparatus should be used. In doing so, a problem of taking a long time for the operation, a problem of it being necessary to spend money for the bonding apparatus, and the like arise.

In the present specification, the release of air refers to letting air, which is formed in the boundary surface between a film and an adherend surface when the film is attached to the adherend surface, out of the boundary surface. The accumulation of air refers to a state in which air remains in the boundary surface. Pushing out air refers to pushing the accumulated air out of the boundary surface between the film and the adherend surface, by using a squeegee and the like.

In recent years, cars have been commonly equipped with a car navigation system, hence protective films for automobile use have been utilized for protecting the display of the car navigation system. In a sunny place, the internal temperature of a car greatly increases. Consequentially, once the film is exposed to a high-temperature environment, the adhesive thereof is melted, and as a result, great peel strength is required to remove the film. This leads to problems in that the film is not easily removed, and the adhesive remains on the adherend surface.

A film, which uses styrene-ethylene-butadiene-styrene (SEBS) or silicone as a base polymer of the adhesive, is known. The adhesive using SEBS as a base polymer has a problem with heat resistance. The adhesive using silicone as a base polymer has a problem in that low-molecular weight siloxane comprised in the silicone is volatilized and adheres to contact portions of electronic parts such as a motor and a relay switch, and SiO₂ as a decomposition product of the siloxane causes contact failure by acting as an electrical insulant. It is also known that an acrylic polymer is used as a base polymer of the adhesive.

JP-A-2000-355678 discloses a removable adhesive sheet useful as a protective sheet, which is used for protecting the surface of a wafer in a step of grinding the rear surface of a semiconductor wafer among steps of producing various semiconductors, an adhesive tape for dicing, which is attached to the rear surface of a wafer in a dicing step of cutting and dividing a semiconductor wafer into small element pieces and automatically collecting the small element pieces by a pick-up method, or the like. However, the removable adhesive sheet has not solved the aforementioned problem of the accumulation of air.

Considering the above situations, the present applicant suggested a removable self-adhesive film including an adhesive layer comprising an acrylic polymer as a base polymer in JP-A-2012-149130. However, in the removable self-adhesive film, the adhesiveness between a substrate layer and the adhesive layer was insufficient. Therefore, the film had problems in that the adhesive layer may be detached from the substrate layer at the time of processing the film, and the type of usable substrate layers is limited.

In order to solve the above problems, the present applicant suggested a removable self-adhesive film, in which a primer layer composed of a polymer that comprises a polyester-based polymer as a main component and has a vinyl group is disposed between an acrylic polymer-comprising adhesive layer and a substrate layer, in Japanese Patent Application No. 2011-218738.

Although the problem of peeling properties was improved in the removable self-adhesive film, when the surface thereof was pressed or swept by a stylus or the like, the adhesive layer might be crushed, and thus the external appearance might deteriorate. That is, the film was not necessarily satisfactory in terms of stylus-friendliness.

### SUMMARY OF THE INVENTION

The present invention has been made to solve the above problems, and provides a removable self-adhesive film which is excellently stylus-friendly.

The present invention provides a removable self-adhesive film which is excellent in the adhesiveness between an adhesive layer and a substrate layer, exhibits excellent removability when a protective film exposed to a high-temperature environment is removed from an adherend surface, can prevent an adhesive from remaining on the adherend surface such that wiping or cleaning is not required after peeling of the film, and can excellently maintain the adhesiveness for reattachment of the film.

The present invention also provides a removable self-adhesive film which makes it possible for air to be efficiently released from the boundary surface between the film and the adherend surface at the time of attachment of the film.

A first aspect of the invention relates to a removable self-adhesive film including a substrate layer, an adhesive layer, and a primer layer between the substrate layer and the adhesive layer, in which the adhesive layer comprises a vinyl group-containing thermoplastic elastomer, an acrylic acid ester, a photopolymerization initiator, and a plasticizer, and the primer layer is composed of a polymer that comprises a polyester-based polymer as a main component and has a hydroxyl group or a vinyl group.

A second aspect of the invention relates to the removable self-adhesive film, in which the thickness of the primer layer is 0.8 μm to 10 μm.

A third aspect of the invention relates to the removable self-adhesive film, in which the plasticizer is any one selected from a group consisting of a carboxylic acid ester, paraffin oil, and naphthene oil.

A fourth aspect of the invention relates to the removable self-adhesive film, in which the substrate layer is composed of any one selected from a group consisting of polyethylene terephthalate (PET), triacetyl cellulose (TAC), polyimide (PI), polyethylene naphthalate (PEN), and polypropylene (PP).

A fifth aspect of the invention relates to the removable self-adhesive film further including a release film on the adhesive layer.

A sixth aspect of the invention relates to the removable self-adhesive film, in which a recording layer is disposed on a surface opposite to the substrate layer surface on which the adhesive layer has been disposed.

According to the first aspect of the invention, since the adhesive layer comprises a vinyl group-containing thermoplastic elastomer, an acrylic acid ester, a photopolymerization initiator, and a plasticizer, a film excellent in elastic force can be obtained. Consequentially, it is possible to prevent the adhesive layer from being crushed and to prevent deterioration of the external appearance even when the surface is pressed or swept by a stylus or the like. That is, it is possible to obtain a removable self-adhesive film which is excellently stylus-friendly.

Moreover, the film has a primer layer, which is composed of a polymer that comprises a polyester-based polymer as a main component and has a hydroxyl group or a vinyl group, between the substrate layer and the adhesive layer. Accordingly, the adhesiveness between the substrate layer and the adhesive layer can be improved. By the improvement of the adhesiveness, the adhesive layer can be prevented from being detached from the substrate layer at the time of processing the film. Furthermore, in terms of optical characteristics, heat resistance, and cost, the range of choice of the substrate can be widened, hence a versatile removable self-adhesive film can be obtained.

In addition, the adhesive layer comprises a vinyl group-containing thermoplastic elastomer, an acrylic acid ester, and a photopolymerization initiator. Accordingly, if the adhesive layer is photopolymerized, when a protective film exposed to a high-temperature environment is removed from an adherend surface, it is possible to peel the film with peel strength that is approximately the same as the strength used for attaching the film, and to prevent the adhesive from remaining on an adherend surface when the film is peeled from the adherend surface. Therefore, a removable self-adhesive film, which does not require wiping or cleaning after peeling and can excellently maintain the adhesiveness for reattachment of the film, can be provided.

Furthermore, since the adhesive layer comprises a plasticizer, air can be efficiently released from the boundary surface between the film and the adherend surface at the time of attaching the film, and a removable self-adhesive film that is easily attachable even in large-sized POP advertizing can be provided.

According to the second aspect of the invention, the thickness of the primer layer is 0.8 μm to 10 μm. Accordingly, it is possible to provide a removable self-adhesive film superior in the adhesiveness between the substrate layer and the adhesive layer.

According to the third aspect of the invention, the plasticizer is any one selected from a group consisting of a carboxylic acid ester, paraffin oil, and naphthene oil. Accordingly, it is possible to provide a removable self-adhesive film which is excellent in flexibility at a low temperature, makes it possible for air to be easily released from the boundary surface between the film and an adherend surface at the time of attaching the film, and exhibits excellent self-adhesiveness.

According to the fourth aspect of the invention, the substrate layer is composed of any one selected from a group consisting of polyethylene terephthalate (PET), triacetyl cellulose (TAC), polyimide (PI), polyethylene naphthalate (PEN), and polypropylene (PP). Accordingly, it is possible to provide a removable self-adhesive film that can prevent scratching of an adherend surface.

According to the fifth aspect of the invention, since a release film is disposed on the adhesive layer, the adhesive layer having not been attached can be protected.

According to the sixth aspect of the invention, images, letters, and the like can be recorded on the removable self-adhesive film.

### DETAILED DESCRIPTION OF THE INVENTION

Hereinafter, the removable self-adhesive film according to the present invention will be described.

In the present invention, the term “self-adhesiveness” means the properties of a film that make it possible to attach the film to an adherend surface without using any other adhesives, pressure or heat, and mechanical means such as a thumbtack, a screw, a stapler, a nail, and a wire.

The total thickness of the removable self-adhesive film of the present invention can be appropriately determined in consideration of required durability, flexibility, and the like. For example, the total thickness is preferably 15 μm to 500 μm, and more preferably 30 μm to 135 μm. If the removable self-adhesive film of the present invention is attached to an adherend surface such as a display screen of televisions or personal computers, the film is preferably transparent such that the screen remains visible. For example, the film is desirably colorless and transparent, but it may be either colored and transparent or opaque.

In the present invention, the substrate layer is positioned outside the adhesive layer when the film of the present invention is attached to an adherend surface, and can function to protect the adhesive layer from an external load. The material used for producing the substrate layer is preferably plastic, and for example, polyethylene terephthalate (PET), triacetyl cellulose (TAC), polyimide (PI), polyethylene naphthalate (PEN), and polypropylene (PP) are preferably used. The thickness of the substrate layer is not limited and can be appropriately determined. For example, the thickness is preferably 10 μm to 350 μm, and more preferably 25 μm to 70 μm. The substrate layer surface facing outside when the film is attached, that is, the surface opposite to a surface on which the primer layer and the adhesive layer are disposed, can be subjected to surface treatment such as hard coating as necessary. Moreover, functions of improving scratch resistance and chemical resistance and preventing fingerprint and reflection can be added to the surface.

The substrate layer can comprise other additives such as a pigment, a dye, an antioxidant, a filler, a UV absorbent, an antistatic agent, and/or an electromagnetic wave shield agent.

In the present invention, the primer layer is preferably disposed between the substrate layer and the adhesive layer which will be described later. The primer layer can function to improve the adhesiveness between the substrate layer and the adhesive layer.

In the present invention, the primer layer is composed of a polymer that comprises a polyester-based polymer as a main component and has a hydroxyl group or a vinyl group. Examples of the polymer that comprises a polyester-based polymer as a main component and has a hydroxyl group include Vylon 650 manufactured by TOYOBO Co., Ltd. Examples of the polymer that comprises a polyester-based polymer as a main component and has a vinyl group include an easily adhesive coat film (Panacrea AC-X manufactured by PANAC Co., Ltd.).

In the present invention, the phrase “has a hydroxyl group or a vinyl group” means that a monomer having a hydroxyl group or a vinyl group may be in a state of being introduced into a main chain of the polyester-based polymer, a state of being incorporated into the polyester-based polymer by graft polymerization, or a state of being physically bonded to the polyester-based polymer.

Since the primer layer is composed of a polymer that comprises a polyester-based polymer as a main component and has a hydroxyl group or a vinyl group, the adhesiveness between the substrate layer and the adhesive layer can be efficiently improved.

The thickness of the primer layer is not limited and can be appropriately determined. The thickness is preferably 0.8 μm to 10 μm, and more preferably 1 μm to 4 μm. If the thickness of the primer layer is less than 1 μm, it is not preferable since the adhesiveness between the adhesive layer and the substrate layer becomes insufficient. If the thickness of the primer layer exceeds 10 μm, it is not preferable since roll pass and drying of the film become difficult.

The adhesive layer is disposed on the other surface of the primer layer and can function to adhere to an adherend surface. The adhesive layer comprises a vinyl group-containing thermoplastic elastomer, an acrylic acid ester, a photopolymerization initiator, and a plasticizer.

The thickness of the adhesive layer is not limited and can be appropriately determined. For example, the thickness is preferably 5 μm to 100 μm, and more preferably 5 μm to 50 μm.

The vinyl group-containing thermoplastic elastomer is not particularly limited as long as it is a thermoplastic elastomer comprising a vinyl group.

The acrylic acid ester is not particularly limited, and for example, methyl acrylate, ethyl acrylate, or butyl acrylate can be preferably used.

In the present invention, the adhesive layer comprises a photopolymerization initiator. When the adhesive layer is irradiated with UV rays after being coated onto the substrate layer or the primer layer, an unsaturated group of the acrylic acid ester is coupled with the thermoplastic elastomer by photopolymerization and becomes a polymer. Moreover, the polymer is hardened, and thus the adhesive layer can be formed into a sheet.

As the photopolymerization initiator, a hydrogen abstraction-type photopolymerization initiator and a cleavage-type photopolymerization initiator are used. Examples of the type of the hydrogen abstraction-type photopolymerization initiator include any one of the benzophenone-based compounds, thioxanthone-based compounds, and the like or a mixture as a combination of two or more types of these compounds, but the examples are not limited to these. Examples of the type of the cleavage-type photopolymerization initiator include any one of the benzoin ether-based compounds, benzyl ketal-based compounds, acetophenone-based compounds, and the like or a mixture as a combination of two or more types of these compounds, but the examples are not limited to these. The amount of the photopolymerization initiator to be added is not limited and can be appropriately determined. For example, the amount is preferably within a range from 0.05 parts by mass to 5 parts by mass, and particularly preferably within a range from 0.1 parts by mass to 3.0 parts by mass, with respect to a total of 100 parts by mass of the vinyl group-containing thermoplastic elastomer and the acrylic acid ester.

In the present invention, the adhesive layer comprises a plasticizer. The plasticizer can function to improve flexibility, air release properties, weather resistance, and the like. Examples of materials of the plasticizer include a carboxylic acid ester, paraffin, naphthene, and the like, and it is particularly preferable to use a carboxylic acid ester. Examples of the carboxylic acid ester include adipic acid ester, phthalic acid ester, trimellitic acid ester, orthophosphoric acid ester, ricinoleic acid ester, acetic acid ester, and the like, but the examples are not limited to these. Among these, it is desirable to use adipic acid ester. The amount of the plasticizer to be added is not limited and can be appropriately determined. For example, the amount is preferably within a range from 5 parts by mass to 95 parts by mass, and particularly preferably within a range from 10 parts by mass to 90 parts by mass, with respect to a total of 100 parts by mass of the vinyl group-containing thermoplastic elastomer and the acrylic acid ester. If the content of the plasticizer is less than 5 parts by mass with respect to a total of 100 parts by mass of the vinyl group-containing thermoplastic elastomer and the acrylic acid ester, air cannot be efficiently released. In contrast, if the content of the plasticizer exceeds 95 parts by mass with respect to a total of 100 parts by mass of the vinyl group-containing thermoplastic elastomer and the acrylic acid ester, bleed-out of the plasticizer occurs. For this reason, the amount of the plasticizer to be added is determined within the above range.

The plasticizer comprised in the adhesive layer is useful for causing air to be efficiently released from the boundary surface between the film and an adherend surface when the film is attached to an adherend surface. Specifically, when the film comes into contact with the adherend surface, the plasticizer on the film surface is diffused throughout the adherend surface. As a result, air is pushed to the outside, whereby air is efficiently released.

Adopting the aforementioned constitution, the adhesive layer in the present invention has a strong elastic force. Accordingly, the removable self-adhesive film of the present invention is excellently stylus-friendly. Moreover, the film is also excellent in weather resistance and has been improved in terms of odor. Furthermore, since the adhesive layer is excellent in heat resistance, the removable self-adhesive film of the present invention has advantages that it is not melted even in a high-temperature environment and is easily removed.

The removable self-adhesive film of the present invention preferably further includes a release film on the adhesive layer.

As the release film, it is possible to use plastic films, such as polyethylene terephthalate, polybutylene terephthalate, polyethylene naphthalate, polycarbonate, polyethylene, polypropylene, polystyrene, triacetyl cellulose, poly(meth)acrylate, and polyvinyl chloride, paper, and the like of which the surface has undergone release treatment for providing a silicone release layer to the film.

Furthermore, as the release film, it is possible to use films having undergone release treatment that is for providing a polyolefin release layer instead of the silicone release layer. In this case, silicone does not remain on the adhesive layer, and even when the film is used for electronic parts, it is possible to prevent contact failure caused by volatilization of low-molecular weight siloxane.

The removable self-adhesive film according to the present invention preferably has a functional layer, on a surface that is opposite to the substrate layer surface on which the adhesive layer has been disposed. Examples of the functional layer include a recording layer, a UV shield layer, a heat-ray shield layer, a hard coat layer, or a layer as a combination of these layers.

The recording layer is formed of a material on which images, letters, and the like can be recorded. Examples of the recording layer include an ink image-receiving layer for an ink jet, an ink image-receiving layer for thermal fusion transfer recording, a toner image-receiving layer for electrophotography, a heat-sensitive recording layer, a recording layer for silver halide photography, and the like. The recording layer may have a single-layer structure or a laminate structure.

The UV shield layer shields the film from the light in a region of 200 nm to 340 nm, thereby preventing the recorded images and letters from deteriorating by UV rays. Moreover, the UV shield layer preferably exhibits a high transmittance in the region of visible light. The UV shield layer may be either a reflective layer that shields the film by reflecting UV rays or an absorptive layer that shields the film by absorbing UV rays. The UV shield layer may have a single-layer structure or a laminate structure. When the film includes the recording layer, by mixing a UV absorbent in the recording layer, the function of the UV shield layer can be added to the recording layer.

The heat-ray shield layer has an effect of shielding the film from heat rays. The heat-ray shield layer may be either a reflective layer that shields the film by reflecting heat rays or an absorptive layer that shields the film by absorbing heat rays. The heat-ray shield layer may have a single-layer structure or a laminate structure.

The hard coat layer has antifouling properties and lubricity. Since the hard coat layer has antifouling properties, the film can be more resistant to contamination, and contaminants having adhered to the film can be more easily removed. Furthermore, since the hard coat layer has lubricity, a squeegee or the like can be more smoothly moved for pushing out the accumulated air. The hard coat layer may have a single-layer structure or a laminate structure.

### EXAMPLES

The present invention will be more specifically described based on the following examples. However, the removable self-adhesive film according to the present invention is not limited thereto.

<Preparation of Film>

### Example 1

17.9 parts by mass of syndiotactic 1,2-polybutadiene as a vinyl group-containing thermoplastic elastomer, 0.55 parts by mass of trimethylolpropane triacrylate as an acrylic acid ester, 0.5 parts by mass of 1-hydroxy-cyclohexyl-phenyl-ketone as a photopolymerization initiator, and 9 parts by mass of bis(2-ethylhexyl)adipate as a plasticizer were mixed together and melted while stirring, thereby preparing an adhesive composition.

Meanwhile, a PET film having a thickness of 50 μm as a substrate layer was coated with a primer (Vylon 650 manufactured by TOYOBO Co., Ltd.) composed of a polymer, which comprises a polyester-based polymer as a main component and has a hydroxyl group, by a bar coating method such that the thickness thereof became 4 μm after drying. Thereafter, the resultant was dried for 2 minutes at 100° C. and cured for 5 days at 45° C., thereby forming a primer layer.

The primer layer side of the film including the substrate layer and the primer layer was coated with the aforementioned adhesive composition, thereby forming an adhesive layer having a thickness of 25 μm. To the adhesive layer, a PET film having a thickness of 25 μm was bonded as release liner. Subsequently, the adhesive layer was irradiated with UV rays at 300 mJ/cm² by using a high-pressure mercury lamp, thereby obtaining a sample of Example 1.

### Example 2

A sample of Example 2 was obtained under the same conditions as in Example 1, except that in Example 1, an easily adhesive coat film (Panacrea AC-X manufactured by PANAC Co., Ltd.) was used as a primer layer. Herein, Panacrea AC-X is composed of a polymer that comprises a polyester-based polymer as a main component and has a vinyl group.

### Example 3

A sample of Example 3 was obtained under the same conditions as in Example 1, except that in Example 1, a primer was coated such that the thickness thereof became 0.1 μm after drying.

### Example 4

A sample of Example 4 was obtained under the same conditions as in Example 1, except that in Example 1, an easily adhesive coat film (Panacrea AC-X manufactured by PANAC Co., Ltd.) having a thickness of 0.1 μm was used as a primer layer.

### Example 5

A sample of Example 5 was obtained under the same conditions as in Example 1, except that in Example 1, an easily adhesive coat film (Panacrea AC-X manufactured by PANAC Co., Ltd.) having a thickness of 1 μm was used as a primer layer, and an ink image-receiving layer for ink jet having a thickness of 50 μm was formed as a recording layer on a surface opposite to the substrate layer surface on which the adhesive layer had been disposed.

### Comparative Example 1

A sample of Comparative Example 1 was obtained under the same conditions as in Example 1, except that in Example 1, a primer layer was not formed.

### Comparative Example 2

A polymer of an acrylic acid ester composed of 1.2 mol of 2-ethylehxyl acrylate and 0.3 mol of 2-hydroxyethyl acrylate was reacted with 0.28 mol of 2-methacryloyloxyethyl isocyanate, thereby obtaining an acrylic acid ester-based copolymer.

To 100 parts by mass of the acrylic acid ester-based copolymer, 0.1 parts by mass of 1-hydroxy-cyclohexyl-phenyl-ketone as a photopolymerization initiator and 60 parts by mass of bis(2-ethylhexyl)adipate as a plasticizer were added, and the resultant was melted while stirring, thereby obtaining an adhesive composition.

Meanwhile, a PET film having a thickness of 50 μm as a substrate layer was coated with an easily adhesive coat film (Panacrea AC-X manufactured by PANAC Co., Ltd.), by a bar coating method such that the thickness thereof became 0.1 μm after drying. The resultant was dried for 2 minutes at 100° C. and cured for 5 days at 45° C., thereby forming a primer layer.

The primer layer side of the film including the substrate layer and the primer layer was coated with the aforementioned adhesive composition, thereby forming an adhesive layer having a thickness of 25 μm. To the adhesive layer, a PET film having a thickness of 25 μm was bonded as release liner. Subsequently, the adhesive layer was irradiated with UV rays at 300 mJ/cm² by using a high-pressure mercury lamp, thereby obtaining a sample of Comparative Example 2.

<Measurement of Adhesive Force>

Each of the samples of Examples 1 to 5 and Comparative Examples 1 and 2 that was cut in a width of 25 mm was bonded to a PET film having a thickness of 188 μm. Subsequently, the peel strength (adhesive force) of each sample was measured after it was left to stand for 30 minutes at room temperature, 24 hours at 80° C., and 24 hours at 110° C. For bonding the sample to the PET film, a reciprocating rubber roller with a load of 2 kg was pressed against the sample. Furthermore, a peel angle was set to 180°, and a peel rate was set to 300 mm/min.

The results are shown in the following Table 1.

<Measurement of Air Release Speed>

Each of the samples of Examples 1 to 5 and Comparative Examples 1 and 2 was laid flat, the adhesive layer up.

Both the short sides of a PET film having a thickness of 125 μm cut in 40 mm×90 mm were pinched in a pinching tool such that the film formed the shape of a loop, and the film was placed on each sample, the surface of the adhesive layer up. The film was then released from the pinching tool, and the speed at which air is released from the boundary between the PET film and the adhesive layer was measured.

The results are shown in the following Table 1.

<Measurement of Push-Out Properties of Air>

Each of the samples of Examples 1 to 5 and Comparative Examples 1 and 2 cut in the A4-size was bonded to glass by hand, and how easily the trapped air bubbles could be pushed out by using a squeegee was confirmed.

A: Air bubbles could be pushed out before the squeegee operation was performed three times.

B: Air bubbles could not be pushed out even after the squeegee operation was performed three times.

The results are shown in the following Table 1.

<Evaluation of Stylus-Friendliness>

Each of the samples of Examples 1 to 5 and Comparative Examples 1 and 2 was bonded to a glass plate, the substrate surface of the sample was swept by the tip of a polyethylene stylus, of which the tip had a diameter of about 2 mmφ, with a load of 500 g, and then the extent of deformation of the adhesive layer was confirmed.

A: The adhesive layer was not crushed.

B: The adhesive layer was crushed.

The results are shown in the following Table 1.

<Evaluation of Adhesiveness Between Adhesive Layer and Substrate Layer>

Each of the samples of Examples 1 to 5 and Comparative Examples 1 and 2 was placed on a flat table, the adhesive layer up. Thereafter, the adhesive layer was rubbed with a finger, and the degree of adhesiveness between the adhesive layer and the substrate was confirmed.

A: The adhesive layer was not easily peeled.

B: The adhesive layer was slightly peeled.

C: The adhesive layer was easily peeled.

The results are shown in the following Table 1.

TABLE 1

| | | | Example | | | | | Comparative Example | |
|---|---|---|---|---|---|---|---|---|---|
| | | | 1 | 2 | 3 | 4 | 5 | 1 | 2*² |
| Constitution | Substrate | Material | PET | PET | PET | PET | PET | PET | PET |
| | | | | | | | including | | |
| | | | | | | | ink image- | | |
| | | | | | | | receiving | | |
| | | | | | | | layer | | |
| | | Thick- | 50 μm | 50 μm | 50 μm | 50 μm | 100 μm | 50 μm | 50 μm |
| | | ness | | | | | | | |
| | Primer | Main | Polyester- | Polyester- | Polyester- | Polyester- | Polyester- | — | Polyester- |
| | | poly- | based | based | based | based | based | | based |
| | | mer | polymer | polymer | polymer | polymer | polymer | | polymer |
| | | Functional | Hydroxyl | Vinyl group | Hydroxyl | Vinyl group | Vinyl group | — | Vinyl group |
| | | group | group | | group | | | | |
| | | Coated | 4 μm | 4 μm | 0.1 μm | 0.1 μm | 1 μm | — | 0.1 μm |
| | | amount | | | | | | | |
| | Adhesive layer*¹ | | Vinyl group- | Vinyl group- | Vinyl group- | Vinyl group- | Vinyl group- | Vinyl group- | Acrylic |
| | | | containing | containing | containing | containing | containing | containing | polymer |
| | | | thermoplastic | thermoplastic | thermoplastic | thermoplastic | thermoplastic | thermoplastic | |
| | | | elastomer + | elastomer + | elastomer + | elastomer + | elastomer + | elastomer + | |
| | | | acrylic acid | acrylic acid | acrylic acid | acrylic acid | acrylic | acrylic | |
| | | | ester | ester | ester | ester | acid ester | acid ester | |

| | | | | | | | | |
|---|---|---|---|---|---|---|---|---|
| Adhesive | RT × 0.5h | 0.009 | 0.008 | 0.008 | 0.009 | 0.006 | 0.009 | 0.015 |
| force | 80° C. × 24h | 0.027 | 0.023 | 0.025 | 0.024 | 0.028 | 0.032 | 0.019 |
| | 110° C. × 24h | 0.102 | 0.109 | 0.098 | 0.101 | 0.114 | 0.135 | 0.038 |

| | | | | | | | |
|---|---|---|---|---|---|---|---|
| Air release properties (cm/sec) | 2.0 | 1.9 | 2.0 | 2.0 | 2.0 | 1.9 | 2.0 |
| Push-out properties of air | A | A | A | A | A | A | A |
| Stylus-friendliness | A | A | A | A | A | A | B |
| Adhesiveness between adhesive | A | A | B | B | A | C | A |
| and substrate | | | | | | | |

*¹Thickness . . . Adhesive layer: 25 μm
*²Comparative Example 2: Constitution of prior application (Japanese Patent Application No. 2011-218738)

Regarding the stylus-friendliness, in all of the samples of Examples 1 to 5 comprising the vinyl group-containing thermoplastic elastomer and an acrylic acid ester as the adhesive layer, the adhesive layer was not crushed, and the sample were more stylus-friendly than the sample of Comparative Example 2 comprising an acrylic polymer as the adhesive layer is.

Regarding the adhesiveness between the adhesive and the substrate, in all of the samples of Examples 1 to 5, the adhesive layer was not easily peeled, and the samples were superior in the adhesiveness compared to the samples of Comparative Example 1 not having the primer layer. Furthermore, by controlling the thickness of the primer layer to become 4 μm after drying (Examples 1 and 2), the adhesiveness equivalent to that of the sample of Comparative Example 2 could be obtained. By an additional test, it was confirmed that excellent adhesiveness can be obtained by controlling the thickness of the primer layer to be 1 μm or greater after drying.

Regarding the adhesive force, in all of the samples of Examples 1 to 5, sufficient removability was obtained even though the removability was slightly inferior to that of Comparative Example 2, and the residue of the adhesive layer did not remain on the PET film after the adhesive layer was peeled.

Regarding the air release properties, in all of the samples of Examples 1 to 5, air was not accumulated, and the air release speed was equivalent to that of Comparative Example 2.

As is evident from the above results, the removable self-adhesive film of the present invention has excellent stylus-friendliness that prevents a mark from leaving on the film even if the film is swept by a stylus or the like.

Moreover, regarding the adhesiveness between the adhesive layer and the substrate layer, it is understood that sufficient adhesiveness can be secured by controlling the amount of the primer used for coating (thickness of the primer layer). Furthermore, it is understood that even after the film is exposed to a high-temperature environment, it can be peeled with a weak force, and the air release properties in the boundary surface between the film and an adherend surface are excellent.

<Measurement of Hardness>

Each of the samples of Example 1 and Comparative Example 2 was placed on a nano-indentation tester (ENT-2100 manufactured by ELIONIX, Inc.), the adhesive layer down and the substrate layer up. Thereafter, an indenter with a tip having the shape of a regular triangular pyramid (Berkovich tip) made of a diamond chip was pushed into the surface of the sample, with a maximum test force F_max=100 mN, and the hardness of six samples was measured for each example. The results are shown in the following Table 2.

TABLE 2

| | | | | Depth of | |
|---|---|---|---|---|---|
| | | | | indentation | |
| | | | | leaving after | |
| | | Maximum | Maximum | indenter is | Young's |
| | | test force | indentation depth | removed | modulus |
| | No. | F_max [mN] | h_max [μm] | h_p [μm] | E_IT [N/mm²] |
| Example 1 | 1 | 100 | 5.99178 | 1.78633 | 1862 |
| | 2 | 100 | 5.9947 | 1.77073 | 1881 |
| | 3 | 100 | 5.89229 | 1.73598 | 1917 |
| | 4 | 100 | 5.98706 | 1.75131 | 1895 |
| | 5 | 100 | 5.89246 | 1.71829 | 1940 |
| | 6 | 100 | 5.97635 | 1.70596 | 1909 |
| | Average | | | | 1901 |
| Comparative | 7 | 100 | 7.70348 | 2.04549 | 1183 |
| Example 2 | 8 | 100 | 7.09749 | 1.7339 | 1331 |
| | 9 | 100 | 7.21834 | 1.72918 | 1297 |
| | 10 | 100 | 6.90838 | 1.69643 | 1387 |
| | 11 | 100 | 6.99843 | 1.64999 | 1360 |
| | 12 | 100 | 6.67555 | 1.60862 | 1461 |
| | Average | | | | 1337 |

As is evident from the results of Table 2, the elastic modulus (E_IT) measured by the nano-indentation method is higher in the samples of Example 1 than in the samples of Comparative Example 2, and accordingly, it is considered that Example 1 is excellently stylus-friendly.

The present invention can be suitably used for efficiently protecting surfaces requiring protection, such as a display screen of televisions, personal computers, cellular phones, game consoles, smart phones, and car navigation systems, and can be suitably used as an adhesive window film for POP advertising and the like.

What is claimed is:

1. A removable self-adhesive film comprising:
a substrate layer;
an adhesive layer; and
a primer layer between the substrate layer and the adhesive layer,
wherein the adhesive layer comprises a vinyl group-containing thermoplastic elastomer, an acrylic acid ester, a photopolymerization initiator, and a plasticizer, and the primer layer is composed of a polymer that comprises a polyester-based polymer as a main component and has a hydroxyl group or a vinyl group.

2. The removable self-adhesive film according to claim 1,
wherein the thickness of the primer layer is 0.8 μm to 10 μm.

3. The removable self-adhesive film according to claim 1,
wherein the plasticizer is any one selected from a group consisting of a carboxylic acid ester, paraffin oil, and naphthene oil.

4. The removable self-adhesive film according to claim 1,
wherein the substrate layer is composed of any one selected from a group consisting of polyethylene terephthalate (PET), triacetyl cellulose (TAC), polyimide (PI), polyethylene naphthalate (PEN), and polypropylene (PP).

5. The removable self-adhesive film according to claim 1, further comprising a release film on the adhesive layer.

6. The removable self-adhesive film according to claim 1,
wherein a recording layer is disposed on a surface opposite to the substrate layer surface on which the adhesive layer has been disposed.
